(19) United States
(12) Patent Application Publication
(10) Pub. No.: US 2024/0327175 A1
(43) Pub. Date: Oct. 3, 2024

(54) CRANE WITH LUFFING AID DEVICE AND METHOD FOR LUFFING SUCH A CRANE

(71) Applicant: Liebherr-Werk Ehingen GmbH, Ehingen/Donau (DE)

(72) Inventor: Thomas STANGL, Allmendingen (DE)

(21) Appl. No.: 18/599,005

(22) Filed: Mar. 7, 2024

(30) Foreign Application Priority Data
Mar. 28, 2023 (DE) 10 2023 107 839.9

(51) Int. Cl. B66C 23/82; B66C 23/74

(52) U.S. Cl. CPC B66C 23/823; B66C 23/74

(57) ABSTRACT

The disclosure relates to a crane and a method for luffing the boom of a crane, in particular a mobile lattice boom crane, having an upper carriage and a boom articulated to the upper carriage so as to pivot about a horizontal axis. The boom is braced via a bracing frame mounted on the upper carriage and can be luffed up and down by pivoting the bracing frame. The crane comprises a luffing aid device, which can exert a torque acting in addition to the bracing on the boom for luffing the boom in a flat boom position. The luffing aid device comprises an auxiliary arm pivotably mounted on the upper carriage and connected to the upper carriage via a retaining element and to the boom via a variable-length traction element. The traction element exerts a tractive force on the boom in the direction of the auxiliary arm.

### CROSS REFERENCE TO RELATED APPLICATION

The present application claims priority to German Patent Application No. 10 2023 107 839.9 filed on Mar. 28, 2023. The entire contents of the above-listed application are hereby incorporated by reference for all purposes.

### TECHNICAL FIELD

The present disclosure relates to a crane, in particular a mobile lattice boom crane, and to a method for luffing the boom of such a crane.

### BACKGROUND

Lattice boom cranes known from the prior art typically comprise a mobile undercarriage, a rotatable upper carriage mounted on the undercarriage and a lattice boom articulated to the upper carriage about a horizontal pivot axis. The latter usually comprises an articulation piece connected to the upper carriage and several lattice sections, which are connected via bolt connections to form a main boom.

### SUMMARY

The booms of lattice boom cranes are typically braced via an additional bracing frame (also known as an A-frame or SA-frame) in order to increase the bracing angle to the boom and thus the leverage around the boom pivot point. The bracing frame is articulated to the upper carriage so that it can pivot about a horizontal pivot axis and is connected to the boom via a bracing system typically comprising several bracing rods. The bracing frame is in turn connected to the upper carriage via a length-adjustable bracing system, the length of which can be actively adjusted using a retraction mechanism. In particular, the bracing frame can be pivoted about its pivot axis by winding and unwinding a bracing cable onto and off of a cable winch on the upper carriage, thereby luffing the boom up and down.

On cranes of this type, the initial raising of the boom from the lowered position is also carried out using the bracing cabling, bracing frame and bracing cabling or retraction mechanism. This arrangement generates a torque that raises the boom in a vertical direction.

However, the problem with long or heavy booms, such as those increasingly required in the recent past (e.g. for erecting larger wind turbines), is that the aforementioned system of bracing, bracing frame and retraction mechanism reaches its limits, as both the cable winch and the bracing are stretched to their maximum load-bearing capacity.

Against this background, the object of the present disclosure is to enable the use of longer and/or heavier booms in cranes of the same type. In particular, the aim is to enable longer or heavier booms to be raised easily and safely without the need for external aids such as an auxiliary crane.

According to the disclosure, this object is achieved by a crane and a method with the features as described herein. Advantageous embodiments of the disclosure are provided in the following description.

Accordingly, on the one hand, a crane, in particular a mobile lattice boom crane, is proposed that comprises an upper carriage and a boom attached to the upper carriage so as to luff or pivot about a horizontal pivot axis. In particular, the upper carriage is rotatably mounted on a mobile lower carriage. A bracing frame is also articulated on the upper carriage so that it can pivot about a horizontal pivot axis, wherein the bracing frame is part of the boom's bracing. In other words, the boom is braced via the bracing frame, wherein the boom is luffed up and down by pivoting the bracing frame. The boom follows the movement of the bracing frame.

According to the disclosure, the crane comprises a luffing aid device, with which a torque acting in addition to the bracing is exerted on the boom for luffing the boom in a flat boom position. The luffing aid device supports the raising of the boom from a flat, in particular a laid-out position of the boom, in which the raising torque generated by the bracing alone is not sufficient or the raising torque of at least one of the components for generating the raising torque is loaded beyond its capacity or load-bearing capacity.

The luffing aid device comprises an auxiliary arm, which, on the one hand, is pivotably mounted on the upper carriage and, on the other hand, is connected to the upper carriage via a retaining element and to the boom via a variable-length traction element. The traction element is thus arranged between the auxiliary arm and the boom designed to exert a tractive force on the boom in the direction of the auxiliary arm, which supports the raising process. The torque generated by the traction element acts in addition to the torque applied via the bracing frame and bracing, so that the boom can also be lifted from a flat or lowered position without overloading the bracing or the retraction mechanism.

The arrangement of the variable-length traction element between the boom and the auxiliary arm means that it can remain on the crane throughout operation, meaning that no complex conversion work is required. At the same time, if the traction element and the auxiliary arm are designed accordingly, this arrangement allows the traction element to be used as a fall-back support when the boom is in a steep position, as it is connected to the boom at the correct point.

By means of the luffing aid device according to the disclosure, it is possible to provide longer and/or heavier booms than previously possible, wherein, in particular during the initial raising process, there is no overloading of the bracing or the retraction mechanism.

The retaining element can also be variable in length or have a fixed length and is used in particular to hold the auxiliary arm in position and build up the required resistance while the variable-length traction element pulls the boom towards the auxiliary arm.

In a possible embodiment, it is provided that the traction element is connected to the auxiliary arm and the boom in an articulated manner. This enables relative movement between the boom and the auxiliary arm. In particular, it may be provided that the auxiliary arm does not pivot together with the boom when the boom is raised in a certain phase, as the traction element is shortened in length when the boom is pivoted. Preferably, the traction element is designed to remain connected to the boom and preferably also to the auxiliary arm during the entire crane operation.

In a further possible embodiment, it is provided that the bracing frame is connected to the upper carriage via an actively adjustable bracing cable. The bracing frame can be pivoted via a retraction mechanism, wherein the bracing cable comprises a bracing cable that can be wound and unwound on a cable winch attached to the upper carriage in particular. The bracing cable is preferably guided via deflection pulleys on the upper carriage and bracing frame. A preferred embodiment is one in which the cable is guided over several deflection pulleys on the bracing frame and several deflection pulleys on the upper carriage, i.e. is reeved in several times and the bracing cabling thus forms a pulley block. The cable winch is designed to pivot the bracing frame towards the rear of the upper carriage by winding up the bracing cable, thereby luffing the boom coupled to the bracing frame via the bracing.

In a further possible embodiment, it is provided that the traction element represents a separate element from the bracing, from the bracing frame and from the boom. The additional tractive force for the raising of the boom is exerted specifically via the additional, variable-length traction element and is therefore not merely a by-product of an existing element of the bracing, the bracing frame or another element of the crane.

In principle, it is conceivable that the variable-length traction element is only passively variable in length, so that in particular the tractive force exerted on the boom depends on the relative angle between the boom and the auxiliary arm. For example, the traction element could comprise a spring element or be designed as such. In this case, the tractive force is greatest at the beginning of the raising process and decreases as the boom angle increases. The tractive force of the traction element alone is not sufficient to luff the boom. For this purpose, an additional righting moment must be applied by the bracing.

With a traction element that only operates passively, however, the tractive force cannot be influenced or changed. It is also not possible to use the traction element as a fall-back support.

In another possible embodiment, it is therefore provided that the traction element is actively adjustable in length. This allows an additional tractive force to be actively applied to the boom and this tractive force can preferably be controlled and/or adjusted in a targeted manner. An electrical control unit is preferably provided for this purpose, which in the simplest case can be the crane control unit itself. This also allows the traction element to be actively switched off in certain embodiments, for example if the tractive force via the bracing alone is sufficient for steeper boom positions.

The traction element can be controlled and/or regulated via a control unit such that a constant or variable or varying tractive force is applied to the bracing frame or boom over time and/or over the pivot angle of the boom. It is conceivable that the cable winch of the bracing cable can be controlled and/or adjusted by the control unit. This allows the control unit to intervene in the raising process depending on the state of the traction element. Synchronized operation of the cable winch and traction element is also possible. The control unit can be a crane control unit or a separate control unit connected thereto.

In a further possible embodiment, it is provided that the traction element is designed as a hydraulic cylinder. The tractive force is generated by pressurizing the hydraulic cylinder via one or more hydraulic pumps and a corresponding control system using an electrical control unit. This also allows the tractive force to be controlled or adjusted depending on certain parameters, such as the boom angle. Alternatively, a cable drive or a spindle drive would be conceivable as an actuator.

Preferably, the traction element is designed as a double-acting hydraulic cylinder, by means of which both a tractive force and a compressive force can be applied to the boom depending on the pressurization of the cylinder. This embodiment makes it possible to use the traction element not only as a raising aid, but also as a hydraulic fall-back support after the raising process, which prevents the boom from tipping over towards the rear of the upper carriage.

In a further possible embodiment, it is provided that the traction element can be controlled and/or adjusted via at least one hydraulic pump and a control unit of the crane in such a way that the traction element exerts a tractive force on the boom in a first angular range of the boom to support the luffing process. The first angle range preferably refers to flat boom positions, in particular between a lowered boom position and a defined first limit angle up to which support of the raising process by the additionally generated tractive force is required. The limit angle can be stored directly in the control unit or the limit angle can be derived from another variable, e.g. a limit force in the bracing or a limit angle of the bracing frame.

In a further possible embodiment, it is provided that the traction element is configured to exert a compressive force on the boom in a third angle range of the boom, in which the boom has a steeper boom position in particular than in the first angular range, directed away from the upper carriage. In the third angle range, the traction element functions in particular as a fall-back support for the boom. In this range, the tractive force or the corresponding torque that can be applied via the bracing alone is sufficient to pivot the boom, so that no additional tractive force is required. Therefore, the traction element can preferably be used as a fall-back support. Due to the arrangement between the auxiliary arm and boom and the pivoting of the auxiliary arm, the traction element does not need to be converted for this purpose.

Preferably, the control unit is configured to allow hydraulic oil to flow out of the traction element or flow into the traction element in a controlled manner in the third angle range using a characteristic curve. This means that the fall-back support can be operated as intended and provide the optimum force for each boom position.

In a further possible embodiment, it is provided that the traction element is designed as a fall-back support or the traction element is designed in such a way that it can be used as a fall-back support in addition to its function as a raising aid. The auxiliary arm is preferably configured to act as a tension-loaded abutment for the traction element in a fall-back support mode of the traction element, so that the drop-back support is stably mounted and can transfer the generated compressive force into the boom. The connection between the traction element and the auxiliary arm must therefore be designed so that it can work in both traction and compression. In fall-back support mode, the fall-back support or the traction element can preferably be supported on the upper carriage.

In a further possible embodiment, it is provided that the crane further comprises a measuring device communicatively connected to the control unit, wherein the control unit is configured to switch off the traction element as a function of a variable detected by the measuring device. The detected variable can be an angle (e.g. an angle of the boom and/or an angle of the bracing frame and/or an angle of the auxiliary arm) and/or a force (e.g. a force in the bracing and/or a force in the bracing cable and/or a force in the traction element and/or a force in the retaining element).

The measuring device preferably comprises at least one of the following sensors:
at least one sensor for detecting an angle of the boom, the bracing frame and/or the auxiliary arm,
at least one sensor for detecting a force in the bracing, the retaining element and/or in the traction element.

Further sensors can be provided, e.g. to detect the speed of the boom and/or the hydraulic pressure in the traction element.

For example, the crane can comprise at least one sensor for detecting an angular position of the bracing frame. This can be done, for example, by detecting the position of the cable winch and/or the cable of the bracing frame and/or by directly detecting the angular position of the bracing frame.

The angular position of the boom can be detected indirectly, for example, by detecting the angular position of the bracing frame and/or the auxiliary arm and/or by directly detecting the angular position of the boom using an angle encoder.

Alternatively or additionally, the crane can comprise at least one sensor for detecting the tractive force exerted by the variable-length traction element. This can be done, for example, via a load cell connected to the traction element. By monitoring the tractive forces on the traction element, correct operation during raising and/or in fall-back support mode can be ensured and (in particular in the event of a fault) overloading of the surrounding structure can be prevented.

Alternatively or additionally, the crane can comprise at least one sensor for detecting a position and/or a length of the variable-length traction element. In particular, the end positions (minimum and maximum extension position) of the traction element can be detected using suitable sensors. The end position sensor or sensors report to the control unit when the traction element is fully retracted and/or extended. An end position sensor for detecting and forwarding the maximum extension length of the traction element can be used to detect a fault, e.g. if the bracing rods of the bracing are not connected correctly, and protects the traction element or the crane from damage. An end position sensor for detecting and forwarding a minimum extension length of the traction element (this does not have to correspond to a physically limited minimum length, but can also represent a fixed minimum length) can be used to switch the traction element to a powerless state after the initial raising process has been completed.

The preferably provided control unit receives the signals from the at least one sensor and is configured to control and/or adjust the tractive force applied to the boom via the traction element on the basis of the sensor data. Preferably, the control unit can intervene in the raising process in the event of a fault and stop the cable winch if necessary to prevent damage. Alternatively or additionally, the control unit can be configured to issue a corresponding warning to the operator (e.g. a visual and/or acoustic warning signal).

Preferably, the control unit is configured to carry out the raising process automatically. The process of generating an additional tractive force therefore runs automatically in particular, for example until a defined limit angle of the boom is exceeded and/or a defined limit force (e.g. in the bracing) is undershot and/or a defined limit length of the traction element is undershot. The traction element can then be automatically de-energized by the control unit, for example.

In another possible embodiment, it is provided that the bracing frame and the auxiliary arm can be pivoted independently of each other. The auxiliary arm is preferably passively pivotable and follows the pivoting movement of the boom due to the coupling with the boom via the traction element in a second angular range of the boom. In particular, the second angle range lies between the first and third angle ranges mentioned above. In the second angle range, the boom is preferably luffed up to such an extent that the tractive force that can be applied via the bracing alone is sufficient to pivot the boom. The boom is preferably not yet luffed up so steeply as to require the use of a fall-back support. In this area, the traction element is preferably switched off and retracted. The traction element therefore acts in particular as a coupling element that couples the pivoting movements of the auxiliary arm and boom. In the first angle range, on the other hand, the traction element retracts when the boom pivots (i.e. its length is shortened), so that the auxiliary arm pivots more slowly or not at all with the boom.

In another possible embodiment, it is provided that the retaining element is flexible and preferably comprises a traction cable. The term traction cable is to be interpreted broadly and can also comprise a chain or a combination of a chain and cable.

The retaining element can have a fixed length, i.e. represent a non-variable-length traction element. Alternatively, the retaining element could also be actively adjustable in length and, for example, comprise or represent a hydraulic cylinder that holds the auxiliary arm in position during the raising operation and acts as an abutment.

In another possible embodiment, it is provided that the retaining element is designed to rest on the upper carriage when the traction element transitions to fall-back support mode. In fall-back support mode, it is therefore placed on the upper carriage and, in particular, is not subjected to traction or compression. The retaining element is preferably designed as a traction cable. Thus, the retaining element is preferably only required for the raising process in order to form an abutment for the auxiliary arm or for the variable-length traction element. In fall-back support mode, on the other hand, the folded auxiliary arm in particular forms the abutment for the traction element acting as a fall-back support, which is now under tensile load, so that the retaining element is not required.

In principle, more than one traction element can be provided, for example two traction elements aligned parallel to each other, which are arranged next to each other or parallel to each other. Several traction elements installed at different distances from the boom pivot axis and/or the bracing frame pivot axis are also conceivable.

Preferably, the boom comprises an articulation piece, which is connected in an articulated manner to the upper carriage, and one or more boom pieces (in particular grid pieces), which can be connected to the articulation piece or to each other (in particular can be bolted together). The traction element is preferably connected to the articulation piece.

The disclosure also relates to a method for luffing the boom of the crane according to the disclosure. The starting point for the method is the boom in a flat position, i.e. the boom is luffed up and, in particular, placed on the ground or a support device. This may be the case when setting up the crane before raising the boom for the first time. To luff the boom, the bracing frame connected to the boom via the bracing is pivoted back, in particular by actuating the bracing cable accordingly.

The boom and the bracing frame are coupled together and perform a synchronized pivot movement. The bracing exerts an upward moment on the boom. The variable-length traction element is installed between the auxiliary arm and boom and exerts a tractive force on the boom that is directed towards the auxiliary arm, resulting in a torque that acts in addition to the torque applied via the bracing, which supports the raising of the boom and thus prevents the retraction mechanism from being overloaded. By continuing to pivot the bracing frame backwards towards the rear of the upper carriage, the boom is raised or luffed up.

When the boom is raised, the length of the traction element is shortened in particular in such a way that the auxiliary arm is not moved, at least in the initial raising phase. This means that the bracing frame pivots backwards relative to the auxiliary arm.

At steeper boom positions, the torque required to move the boom is lower than during initial raising, so that pivoting is possible using the bracing alone without overloading the retraction mechanism. As soon as the boom exceeds a certain angle or the traction element is shortened to a certain length, the traction element is therefore preferably deactivated by a control unit so that it no longer exerts any force on the boom. An angle, a force and/or the length of the traction element can be used as a limit value.

The method according to the disclosure obviously results in the same advantages and properties as for the crane according to the disclosure, which is why a repetitive description is dispensed with at this point. The above explanations with regard to the possible embodiments of the crane according to the disclosure therefore apply accordingly to the method.

In a possible embodiment of the method, it is provided that the traction element is used as a fall-back support for the boom after the raising process. Preferably, the fall-back support is only active at certain boom angles, in particular at steep boom angles where the fall-back support is intended to prevent the boom from tipping back. In between, i.e. for less steep boom positions, where pivoting can take place solely via the bracing and the retraction mechanism, the traction element is preferably switched off.

### BRIEF DESCRIPTION OF THE FIGURES

Further features, details and advantages of the disclosure result from the following exemplary embodiments explained with the help of the figures. In the figures:

FIG. 1: shows a side view of the crane according to the disclosure according to an exemplary embodiment;

FIGS. 2-5: show different phases of the boom raising process of the crane, each in a schematic side view; and

FIG. 6: shows a schematic view of the crane according to the disclosure according to a further exemplary embodiment.

### DETAILED DESCRIPTION

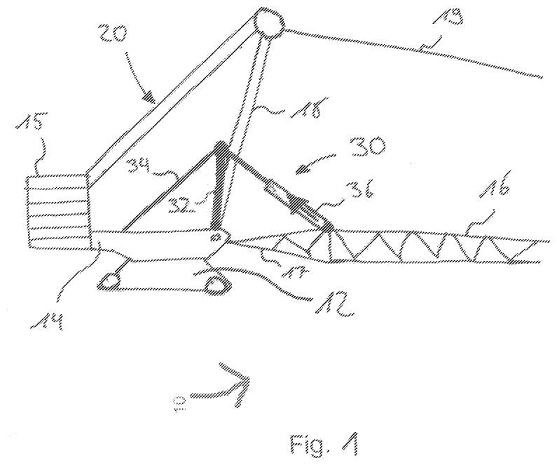

FIGS. 1-5 show a preferred exemplary embodiment of the crane 10 according to the disclosure in roughly schematic side views. The exemplary embodiment of the crane 10 described here is a mobile lattice boom crane 10, which comprises an undercarriage 12 with a crawler chassis and an upper carriage 14 mounted on the undercarriage 12 so as to rotate about a vertical axis of rotation. A lattice boom 16 is articulated to the upper carriage 14 so that it can pivot about a horizontal pivot axis. The boom 16 comprises an articulation piece 17, which is pivotably mounted on the upper carriage 17 and to which one or more lattice sections of the lattice boom 16 are bolted. The connection can be made in the usual way using fork-finger connections.

The boom 16 is braced by a bracing 19 preferably comprising several tension rods. To increase its angle to the boom 16, i.e. to generate a lever to the pivot axis of the boom 16 in order to generate a raising torque, a bracing frame 18 is articulated to the upper carriage 14 so as to pivot about a pivot axis parallel to the boom pivot axis. The boom 16 and bracing frame 18 can be pivoted about the same pivot axis or about parallel, spaced-apart pivot axes. The bracing frame 18 is connected to the boom 16 via the bracing 19, so that pivoting the bracing frame 18 causes the boom 16 to luff up and down. To assemble the bracing 19, the boom 16 is preferably mounted, placed on the ground (or on a trolley), and then the bracing 19 is put together.

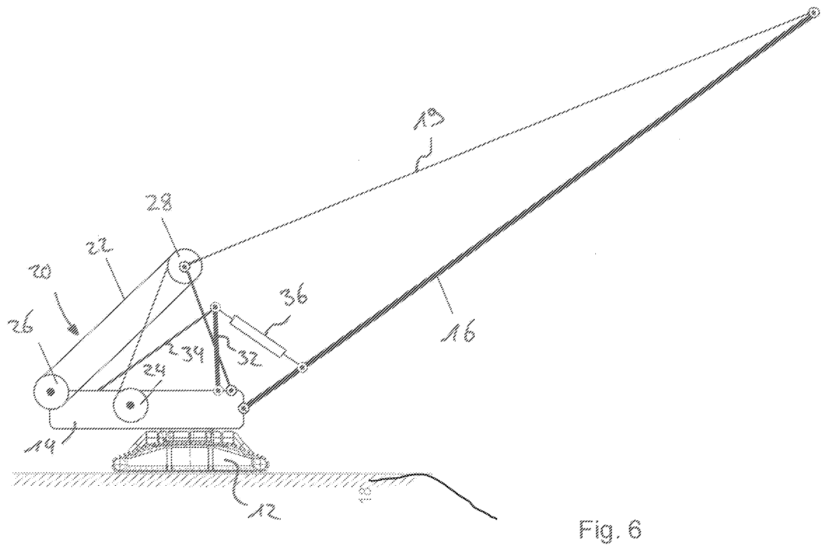

The boom 16 is pivoted and luffed up and down by pivoting the bracing frame 18. This is connected to the upper carriage 14 via a bracing cabling 20 that can be adjusted by means of a retraction mechanism. The bracing cabling 20 in particular comprises a tensioning cable 22, which is mounted on a cable winch 24 arranged on the upper carriage 14 so that it can be wound and unwound. These components are schematically indicated in FIG. 6 on the basis of a specific exemplary embodiment of the crane 10 according to the disclosure and can also be provided in the exemplary embodiment of FIGS. 1-5. The tensioning cable 22 is preferably guided over one or several deflection pulleys 28 mounted rotatably on the bracing frame 18 and one or several deflection pulleys 26 mounted rotatably on the rear of the superstructure, so that the bracing cable 20 forms a pulley block. The torque required to raise the boom 16 is therefore generated by the retraction mechanism or cable winch 24. The tractive force of the bracing cabling 20 is transferred to the boom 16 via the bracing 19.

FIG. 1 shows the crane 10 with a boom 16 laid out (e.g. after boom assembly, before the crane 10 has been put into operation by raising the boom 16). If the boom 16 is now to be raised from this position, a high torque is required due to the low boom angle or the flat boom position. If this is to be applied solely via the retraction mechanism or the bracing 19, the bracing system or the cable winch 24 may be overloaded if longer or heavier booms 16 are used. To avoid this, an auxiliary crane can be used, for example, to apply additional torque for the initial raising process until the boom 16 can then be pivoted within its load limit at larger angles using the retraction mechanism alone.

According to the disclosure, a different approach is taken, which enables the use of larger, heavier booms without having to rely on external auxiliary equipment. According to the disclosure, the crane 10 has an integrated luffing aid device 30, which generates an additional raising torque during the initial luffing process of the boom 16 in order to relieve the load on the retraction mechanism or the bracing 19.

The luffing aid device 30 comprises an auxiliary arm 32, which is pivotably attached to the upper carriage 14 about a horizontal pivot axis. The auxiliary arm 32 can be pivoted about the same axis as the boom 16 and/or the bracing frame 18 or about a parallel axis spaced apart therefrom. The auxiliary arm 32 is connected to the upper carriage 14 via a retaining element 34. The luffing aid device 30 further comprises variable-length traction element 36, which is connected, on the one hand, in an articulated manner to the boom 16, in particular to the articulation piece 17, and on the other hand, in an articulated manner to the auxiliary arm 32, in particular to its end spaced apart from the upper carriage 14.

An additional tractive force F₂ or a corresponding additional moment is exerted on the boom 16 via the variable-length traction element 36, which acts on the boom 16 in addition to the force F₁ generated via the bracing 19. In order to apply the necessary tractive force F₂, the auxiliary arm 32 is secured or held against tilting in the direction of the boom 16 via the holding element 34. The retaining element 34 functions as an abutment for the auxiliary arm 32. By shortening the variable-length traction element 36, the tractive force F₂ and thus a torque that lifts the boom 16 from the ground or directs it upwards is generated.

In the exemplary embodiment shown here, the traction element 36 is designed as an actively adjustable double-acting hydraulic cylinder 36, wherein alternatively an electric actuator, such as an electromechanical drive, a spindle drive, a cable drive or a passive element such as a spring could also be used. The hydraulic cylinder 36 is connected to the hydraulic system of the crane 10 and can be controlled via a control unit (not shown in detail), in particular via the crane control system, in order to generate a desired tractive force in a targeted manner. Depending on the desired control, the traction element 36 can apply a constant or variable tractive force to the boom 16 when raising the boom 16. In the following, the variable-length traction element 36 is also referred to as a “traction cylinder”.

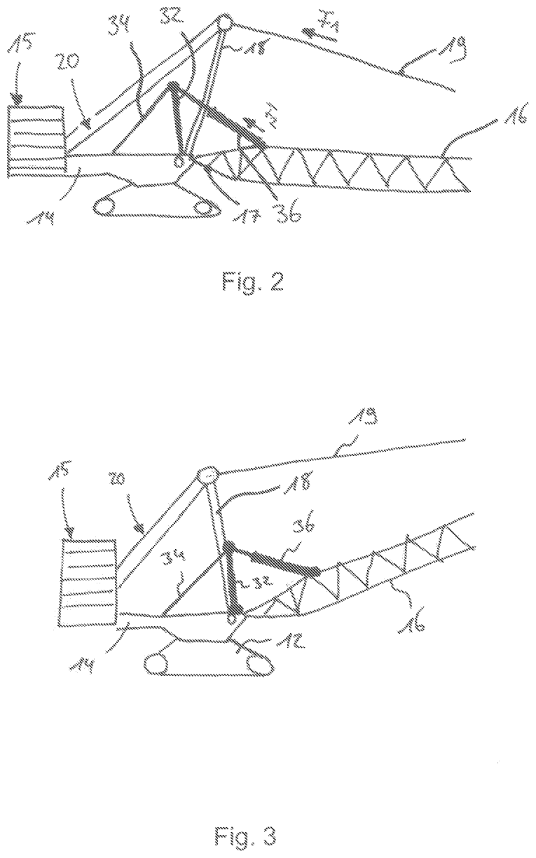

The raising process of the boom 16 by means of the luffing aid device 30 is shown in FIGS. 2-5. In FIG. 2, the boom 16 lies stretched out and is supported on the ground. The force F₁ of the bracing 19 is generated by the cable adjuster 20. This is not always sufficient to lift the boom 16 off the ground. According to the disclosure, an additional force F₂ is introduced into the boom system. This additional force F₂ now generates sufficient torque to lift the boom 16 off the ground. The additional force F₂ is generated by the hydraulic cylinder 36 coupled in an articulated manner with the boom 16 and auxiliary arm 32. This is supplied with hydraulic pressure via one or more hydraulic pumps.

In FIG. 3, the boom 16 has luffed up about its luffing axis and its center of gravity has shifted in the direction of the luffing axis. In this position, in which the boom 16 has a larger boom angle or a steeper position, the force F₁ transmitted via the bracing 19 is sufficient to raise the boom 16 further on its own. It should be noted that the auxiliary arm 32 and the retaining element 34 have not rotated about their articulation points on the upper carriage 14. The geometry has not changed. The traction cylinder 36, on the other hand, has shortened during the raising process. The bracing frame 18 has pivoted with the boom 16, as their movements are interdependent or coupled to each other.

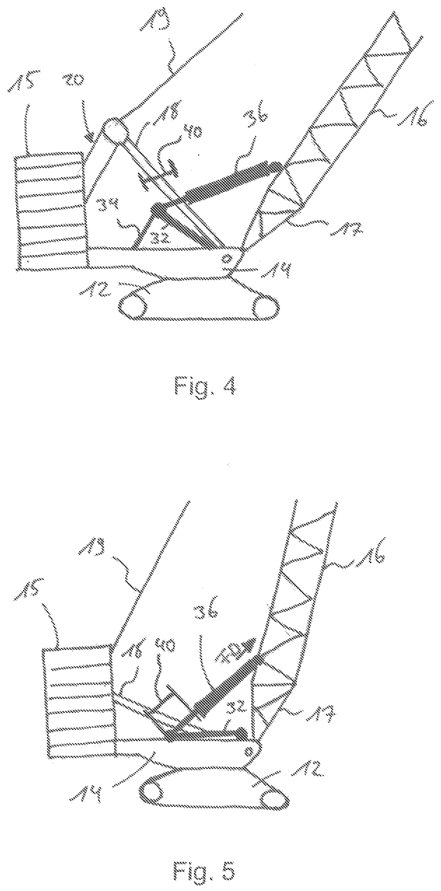

In FIG. 4, the traction cylinder 36 has reached its end position and has retracted according to its geometrically provided boom. The retaining element 34 now begins to rest on the upper carriage 14. Preferably, the retaining element 34 is designed as a traction cable or comprises such a cable. The auxiliary arm 32 pivots about its articulation point on the upper carriage 14 and rests on the upper carriage 14. At this point it should be noted that the terms “articulation point”, “pivot axis” and “luff axis” are used synonymously.

Due to the fact that the traction cylinder 36 is double-acting in the exemplary embodiment shown here, it can be loaded not only in traction but also in compression or exert a compressive force on the boom 16. This allows the traction cylinder to be used as a fall-back press or fall-back support for the boom 16 when it is in a steep position.

FIG. 5 shows a possible fall-back support mode of the traction cylinder 36. As soon as the auxiliary arm 32 is fully placed on the upper carriage 14, the auxiliary arm 32 acts as an abutment for the traction cylinder 36 and is subjected to tensile load. This allows the pull cylinder 36 to build up a compressive force F_{D} and act as a fall-back support against the boom 16. The connection between the traction cylinder 36 and the auxiliary arm 32 must therefore be able to work in traction and in compression and is designed accordingly.

The length of the traction cylinder 36 is suitably selected for the geometric requirements. Hydraulic medium must flow from the traction cylinder 36 in a controlled manner as the boom 16 continues to luff up. The compression is preferably controlled or adjusted according to a predetermined characteristic curve in order to operate the fall-back device as intended. The path or distance 40 indicated in FIG. 5 is provided for this purpose in order to be able to follow the movement of the boom 16. The piston rod of the traction cylinder 36 is therefore not fully retracted in fall-back support mode, but remains extended by a distance 40.

In this solution, the force ratios in the traction cylinder 36 for the drop-back support operation are therefore preferably reversed by the control system and the traction cylinder 36 acts as a compression member. The wiring of the hydraulic traction cylinder 36 is adapted to the requirements of operation. In the case of flat boom positions after the initial luffing up, the traction cylinder 36 can be switched off by the control system, as there is no fall-back issue here and the force F₁ generated by the retraction mechanism or transmitted by the bracing 19 is sufficient to pivot the boom 16.

Switching off can be carried out on the basis of measured sensor values. For example, the boom angle can be measured and/or the force in the bracing 19 can be measured. In the case of force measurement, a comparison can be made against a limit force and in the case of angle measurement against a limit angle. Other or additional measurements are also conceivable, for example the angle of the bracing frame 18, the angle of the auxiliary arm 32, the force in the traction cylinder 36 (and/or a hydraulic pressure in the traction cylinder 36 or in the hydraulic system), the force in the retaining element 34 and/or the force in the bracing cabling 20.

The controller or control unit can be configured to control and/or adjust both the traction cylinder 36 and the retraction mechanism or the cable drum 24.

Preferably, the discussed raising process, the switching off and the fall-back support mode are at least partially automated, optionally even fully automated, so that the crane operator does not have to switch manually between these modes. Instead, the controller automatically switches between the different modes (flat boom positions: raising aid—combined tractive force F₁+F₂; middle boom positions: switched off traction element 36—tractive force F₁; steep boom positions: fall-back support mode—tractive force F₁ and possible compressive force F_{D}) when luffing up the boom 16.

The traction element 36 preferably remains mounted on the boom 16 (or on the articulation piece 17) and on the auxiliary arm 32 during the entire crane operation.

FIG. 6 shows a side view of a further exemplary embodiment of the crane 10 according to the disclosure, wherein further components of the retraction mechanism or bracing cabling 20 are shown, such as a cable winch 24 mounted on the upper carriage 14 and deflection pulleys 26, 28 on the upper carriage 14 and at the tip of the bracing frame 18 for reeving the bracing cable 22. Here, the pivot axis of the auxiliary arm 32 is offset backwards towards the rear of the upper carriage in relation to the luff axis of the boom 16, which is shown here only schematically as a line, and in relation to the pivot axis of the bracing frame 18. However, it is also conceivable that the pivot axis of the auxiliary arm 32 lies between the pivot axes of the bracing frame 18 and boom 16 or coincides with one of these pivot axes or with both pivot axes.

### LIST OF REFERENCE NUMERALS

10 Crane
12 Undercarriage
14 Upper carriage
15 Upper carriage ballast
16 Boom
17 Articulation piece
18 Bracing frame
19 Bracing
20 Bracing cabling
22 Bracing cable
24 Cable winch
26 Deflection pulley
28 Deflection pulley
30 Luffing aid device
32 Auxiliary arm
34 Retaining element
36 Variable-length traction element
40 Distance
F₁ Tractive force due to retraction mechanism and bracing
F₂ Tractive force due to traction element during raising process
F_{D} Compressive force due to traction element in fall-back support mode

1. Crane, having an upper carriage and a boom articulated to the upper carriage so as to pivot about a horizontal pivot axis, which boom is braced via a bracing frame mounted on the upper carriage so as to pivot about the horizontal pivot axis and can be luffed up and down by pivoting the bracing frame,
comprising
a luffing aid device, with which a torque acting in addition to the bracing can be exerted on the boom for luffing the boom in a flat boom position, wherein the luffing aid device comprises an auxiliary arm, which is pivotably mounted on the upper carriage and which is connected to the upper carriage via a retaining element and to the boom via a variable-length traction element, wherein the traction element is designed to exert a tractive force on the boom in the direction of the auxiliary arm.

2. Crane according to claim 1, wherein the traction element is connected in an articulated manner to the auxiliary arm and the boom and is designed to remain connected to the boom and also to the auxiliary arm during the entire crane operation.

3. Crane according to claim 1, wherein the bracing frame is connected to the upper carriage via an actively adjustable bracing cabling, which comprises a bracing cable mounted on a cable winch so that it can be wound up and unwound, wherein the cable winch is designed to pivot the bracing frame towards a rear of the upper carriage by winding up the bracing cable and thereby to luff the boom coupled to the bracing frame via the bracing.

4. Crane according to claim 1, wherein the traction element is a separate element from the bracing, from the bracing frame and from the boom.

5. Crane according to claim 1, wherein the traction element is actively adjustable in length and is controllable and/or adjustable in such a way that it exerts a constant or varying tractive force on the boom when the boom is luffed upwards.

6. Crane according to claim 1, wherein the traction element is designed as a hydraulic cylinder.

7. Crane according to claim 6, wherein the traction element can be controlled and/or adjusted via at least one hydraulic pump and a control unit of the crane in such a way that the traction element applies a tractive force to the boom in a first angular range of the boom to support the luffing process.

8. Crane according to claim 7, wherein the traction element is configured to exert a compressive force directed away from the upper carriage on the boom in a third angular range of the boom, in which the boom has a steeper boom position than in the first angular range.

9. Crane according to claim 6, wherein the traction element is designed as a fall-back support, wherein the auxiliary arm is configured to function as an abutment for the traction element when the traction element is in a fall-back support mode.

10. Crane according to claim 7, further comprising a measuring device communicatively connected to the control unit, wherein the control unit is configured to switch off the traction element as a function of a variable detected by the measuring device.

11. Crane according to claim 1, wherein the bracing frame and the auxiliary arm are pivotable independently of one another, wherein the auxiliary arm is passively pivotable and follows the pivoting movement of the boom due to the coupling with the boom via the traction element in a second angular range of the boom.

12. Crane according to claim 1, wherein the retaining element is flexible and comprises a traction cable.

13. Crane according to claim 1, wherein the retaining element is designed such that it is placed on the upper carriage in a fall-back support mode of the traction element and is not loaded.

14. Method for luffing the boom of the crane according to claim 7, comprising:
providing the boom in a flat, laid-out boom position,
pivoting the bracing frameback in order to exert an upwardly directed torque on the boom, wherein at the same time, a tractive force directed towards the auxiliary arm is exerted on the boom via the traction element in order to support the luffing process, and
luffing the boom by continuing to pivot the bracing frame.

15. Method according to claim 14, wherein the traction element is used as a fall-back support for the boom after the raising process, which is only active at certain boom angles and is otherwise switched off.

16. Crane according to claim 1, wherein the crane is a mobile lattice boom crane.

17. Crane according to claim 6, wherein the traction element is designed as a double-acting hydraulic cylinder, by means of which both a tractive force and compressive force can be exerted on the boom.

18. Crane according to claim 10, wherein the measuring device comprises at least the following sensors:
at least one sensor for detecting an angle of the boom, the bracing frame and/or the auxiliary arm;
at least one sensor for detecting a force in the bracing, the retaining element and/or in the traction element.

19. Method according to claim 14, further comprising switching off the traction element when a defined angle is exceeded and/or when a defined force is not reached.

20. Crane according to claim 8, wherein the control unit is configured to allow hydraulic oil to flow out of the traction element or flow into the traction element in a controlled manner in the third angular range using a characteristic curve.
